(19) United States
(12) Patent Application Publication
(10) Pub. No.: US 2015/0043858 A1
(43) Pub. Date: Feb. 12, 2015

(54) BEARING SYSTEM AND METHOD FOR OPERATING A BEARING SYSTEM

(71) Applicants: Wolfgang Aust, Bergrheinfeld (DE); Hubert Herbst, Gädheim (DE); Joerg Wainus, Werneck (DE); Volker Wendt, Üchtelhausen/Zell (DE)

(72) Inventors: Wolfgang Aust, Bergrheinfeld (DE); Hubert Herbst, Gädheim (DE); Joerg Wainus, Werneck (DE); Volker Wendt, Üchtelhausen/Zell (DE)

(73) Assignee: AKTIEBOLAGET SKF, Göteborg (SE)

(21) Appl. No.: 14/452,050

(22) Filed: Aug. 5, 2014

(30) Foreign Application Priority Data
Aug. 7, 2013 (DE) 10 2013 215 557.3

(51) Int. Cl. F16C 39/02; F16C 43/04; F16C 19/34

(52) U.S. Cl. CPC F16C 39/02; F16C 19/34; F16C 43/04
USPC 384/558; 29/898.09

(57) ABSTRACT

A bearing system for supporting components that are movable relative to one another includes at least one bearing and a preload mechanism for changing a preload of the at least one bearing based on an operating state of the bearing system, where the preload mechanism includes, for example, a piezoelectric element, a Peltier element, an expansion material or a micromechanical element.

### CROSS-REFERENCE

This application claims priority to German patent application no. 10 2013 215 557.3 filed on Aug. 7, 2013, the contents of which are fully incorporated herein by reference.

### TECHNOLOGICAL FIELD

The present disclosure is directed to a method and apparatus for adjusting a bearing preload, and, more specifically, to a bearing system having a preload adjustment mechanism and to methods of adjusting a bearing preload.

### BACKGROUND

Bearing systems are used for supporting components that are movable with respect to each other. In such bearing systems, it is sometimes necessary to set a positive or negative bearing operating clearance. In many fields of application a positive operating clearance is desired; that is, during operation, a small residual clearance is present in the bearing.

However, there are also many cases, e.g. bearings of machine tool spindles, pinion bearings in motor-vehicle axle drives/final drives, bearing assemblies in small electric motors, or bearing assemblies having oscillating movements, in which a negative operating clearance, i.e. a preload, is desired. The negative operating clearance/preload helps improve the stiffness of the bearing assembly and/or increase the running accuracy of the bearing.

In many applications the choice of the preload to use is a compromise that takes into account a borderline operating case. That is, a preload is selected that is at least marginally acceptable for a variety of operating conditions but that is optimal for few if any operating conditions. This can have a negative impact on various bearing properties because the bearing system is seldom if ever configured with an optimal preload.

### SUMMARY

There is therefore a need to provide a bearing system in which the preload is adjustable so that the stiffness and/or the load capacity of the bearing can be changed. This, in turn, may increase the lubricant service life of the bearing system, and/or reduce the friction-torque development of the bearing system.

Exemplary embodiments relate to a bearing system or a bearing assembly for supporting components that are movable with respect to one another. The bearing system includes at least one bearing and a preload device. The preload device is configured to change a preload of the bearing based on an actual or intended operating state or operating mode of the bearing system.

Because the preload can be adjusted during the operation of the bearing system, the preload can be set based on the operating state of the bearing system. For example, the preload can be increased if a higher stiffness or load capacity of the bearing system is needed in one operating state, and/or the preload can be reduced if a lower friction torque is desired in another operating state. In this way efficiency can be increased and operating and/or maintenance costs can be reduced. In addition, because such changes to preload can help maintain a lower bearing temperature, the service life of any lubricant used in the bearing can also be extended.

In some exemplary embodiments the preload device includes a Peltier element, a piezoelectric element, an expansion material/expandable material, or a micromechanical element to change the preload of the bearing. Such a preload device can thus be realized in a simple and space-saving manner.

Some exemplary embodiments relate to a bearing system having two bearings, specifically rolling-element bearings, that each have two bearing rings. The preload device can then be disposed outside the two bearings (for example, between the two bearings) and be configured to change a spacing between a bearing ring of the first bearing and a bearing ring of the second bearing. The preload of both bearings can thereby be changed in a simple manner.

In some exemplary embodiments the at least one bearing is a rolling-element bearing having a guide flange for the rolling elements of the rolling-element bearing. In these embodiments, the preload device is configured to change a pressure of the guide flange on the rolling elements of the rolling-element bearing. A possibility for changing the preload can thus be integrated in a space-saving manner.

### BRIEF DESCRIPTION OF THE DRAWINGS

Exemplary embodiments are described and explained in more detail below with reference to the accompanying figures.

FIG. 1 is a schematic cross-sectional view of a spindle bearing.

FIGS. 2a to 2j are schematic cross-sectional views of tapered roller bearings including preload devices.

FIGS. 3a and 3b are schematic cross-sectional views of a tapered roller bearing system including an external preload device.

FIGS. 4a and 4b are schematic cross-sectional views of angular contact ball bearings including preload devices.

FIG. 5 is a schematic cross-sectional view of a bearing system including a preload device which includes a clamping nut having fine adjustment.

### DETAILED DESCRIPTION

In the following description of the accompanying figures, which show exemplary embodiments of the present disclosure, identical reference numerals are used to indicate identical or comparable components. Furthermore, summarizing reference numerals may be used for components and objects that appear multiple times in an exemplary embodiment or in an illustration, but that are described together in terms of one or more common features. Components or objects that are described with the same or summarizing reference numerals can be embodied identically, but also optionally differently, in terms of individual, multiple, or all features, their dimensions, for example, as long as the description does not explicitly or implicitly indicate otherwise.

Some exemplary embodiments relate to a bearing system or a bearing assembly for supporting components which are movable relative to one another. The bearing system of these embodiments includes at least one bearing and a preload device. The preload device is configured to change a preload of the bearing based on an operating state or operating mode of the bearing system. For example, the rigidity or stiffness, the load capacity, and/or the friction torque of the bearing system can be set or configured based on an actual or intended operating state or operating mode of the bearing system.

The aforementioned components which are movable with respect to one another can be any components of a machine. The components may move translationally and/or rotationally with respect to one another. Such a movement is made possible by the at least one bearing disposed between the components which are movable with respect to one another.

The at least one bearing (and/or also one or more further bearings of the bearing system) can be rolling-element bearings or sliding bearings and may further comprises an axial bearing or a radial bearing.

The preload can be either a radial preload or an axial preload, depending on the type of bearing. For example, cylindrical roller bearings can be radially preloaded, and axial ball bearings or axial cylindrical roller bearings can be axially preloaded. Some bearings or assemblies of a plurality of bearings can also be axially and radially preloaded.

A high bearing stiffness can be achieved using a preload. The bearing stiffness (expressed, for example, in kN/μm) may be defined as the ratio of the force acting on the bearing to the elastic deformation in the bearing. For a given load range, the elastic deformation in preloaded bearings may be smaller than in non-preloaded bearings. Preloaded bearings may also operate at a reduced noise level. For example, the smaller the operating clearance of a bearing, the better the guiding of the rolling body elements in the non-loaded zone and thus the quieter the bearing will be in operation. In addition, preloaded bearings allow shafts to be guided in a more precise manner because the preload both reduces the elastic deformation of the bearing itself and reduces the possibility that the shaft will flex under load.

Furthermore, wear processes and setting processes and break-in processes (changes to the size and/or spacing of bearing elements that occur over the operating life of the bearing) can be at least partially compensated for using disclosed embodiments. Wear and setting and break in processes in a bearing assembly during operation can increase bearing clearance; however, this can be at least partially compensated by changing the preload. A suitably dimensioned preload can favorably affect the load distribution in a bearing and thus also increase the bearing service life.

The preload device can be used to change the preload of the bearing. The preload can thus be adapted to different operating states or operating modes of the bearing system. An operating state or mode of the bearing system is any state which the bearing system can assume in operation. For example, states in which the relatively movable components move at different speeds can be different operating states of the bearing system. Thus, in an application in which the components move at high speed, a higher preload (e.g. in order to increase the stiffness of the bearing system) or a lower preload (e.g. in order to reduce the friction torque) may be desired as compared with an application in which the components move at lower relative speeds. Conversely, at low or moderate speeds a lower preload (e.g. in order to reduce the friction torque) or a higher preload can be desirable than with a high or maximum speed operation. Accordingly, to accommodate different load states during operation of the bearing system different preloads can be used in order to obtain a particular behavior (e.g. with respect to friction torque, stiffness, operating noise, or wear).

In other words, the preload device can establish a first preload of the bearing for a first operating state of the bearing system and establish a second preload of the bearing for a second operating state of the bearing system. Here the first preload differs from the second preload, and the first operating state differs from the second operating state. The preload device can thus change the preload of the bearing during operation of the bearing.

In order to change the preload of the at least one bearing of the bearing system, the preload device may include an element that can controllably change its spatial dimension in at least one direction in order to exert a force on adjacent components in the bearing system so that the desired preload is generated in the at least one bearing. For example, the preload device can include a Peltier element, a piezoelectric element, an expandable material, or a micromechanical element to change the preload of the bearing.

Alternatively the preload device can be realized hydraulically. In this case hydraulic fluid can be pressed into a cavity via a supply line so that this hydraulic fluid exerts more or less pressure on a component of the bearing and thus changes the preload of the bearing. A wax can be used, for example, as the expandable material, and at least one dimension of the wax may be changed by electrical heating using, for example, an electric heating element. Alternatively a set screw may be used to control the preload of the at least one bearing via an electric motor. Changing the preload of the at least one bearing can thus be realized in a simple and cost-effective manner.

Optionally, alternatively, or additionally, the bearing system can include a control device which changes the preload of the bearing provided by the preload device based on a detected or determined operating state of the bearing system. The control device can be part of the preload device or a unit which controls the preload device. For example, the control device can provide an electric voltage for a piezoelectric element of the preload device, which electric voltage changes the size or length of the piezoelectric element in order to change the preload of the at least one bearing in a desired manner. In this way a preload of the at least one bearing can be established electronically based on an operating state of the at least one bearing in a simple and cost-effective manner.

Also optionally, alternatively, or in addition, the bearing system can include an operating-state-detection device which recognizes or detects an operating state of the bearing system and that provides information about the detected operating state which information can be used for changing the preload of the bearing. Such an operating state detection device may detect a movement speed or rotational speed of the components which are movable with respect to each other, an operating temperature, an operating load, or a similar parameter which defines an operating state. The operating state detection device may provide this information as an electronic signal (e.g. to a control device or to the preload device) in order to change the preload, based on the electronic signal, depending on the detected operating state of the bearing system. For example, based on the provided information a control device can select a suitable preload (e.g. from a lookup or conversion table), based on the provided information or by a classification of the operating state, or calculate a favorable or optimum preload for the respective operating state. In this way a change of the preload that depends on an operating state can be realized in a simple and cost-effective manner.

The preload device can be disposed at different locations. For example, the preload device can be directly integrated in the at least one bearing (e.g. a rolling-element bearing). Alternatively or additionally a preload device can be disposed between two bearings of a bearing system outside the two bearings. For example, both bearings can be rolling-element bearings, each including two bearing rings (inner ring and outer ring), and the preload device may be disposed outside the two bearings to change a distance between a bearing ring of the first bearing and a bearing ring of the second bearing.

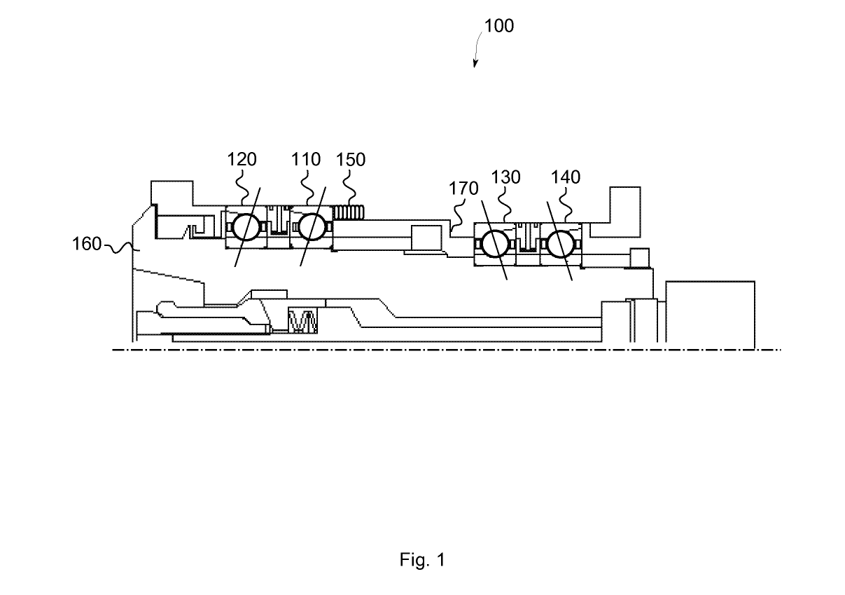

FIG. 1 schematically illustrates a partial cross-section of a spindle bearing 100 according to an exemplary embodiment. Generally, such a spindle bearing 100, as a bearing system, can include a plurality of rolling-element bearings 110, 120, 130, 140, each of which has two bearing rings (an inner ring and an outer ring). The preload device 150 is disposed between at least two of the bearings and is configured to change a distance between a bearing ring of the first bearing 110 and a bearing ring of the second bearing 130.

In FIG. 1 the spindle bearing 100 includes four angular contact ball bearings 110, 120, 130, 140, which are attached via their inner rings to a radially-inner component 160 (e.g. a shaft or a spindle) and connected via their outer rings to a radially-outer component 170 (e.g. a housing). The outer rings of the first bearing 110 and of the second bearing 120 may be axially displaceable at least to a limited extent. In this case, the preload device 150 can be implemented as a piezoelectric actuator or a piezoelectric element which changes in its axial length under the influence of an applied voltage. Due to the relative arrangement of the outer ring of the first bearing 110 and an edge of the outer component 170 which axially abuts on the outer ring of the third bearing 130, a distance between the outer rings of the first bearing 110 and of the third bearing 130 can be changed, and thus the preload of the two bearings can be changed. In the example shown, the outer rings of the second bearing 120 and of the fourth bearing 140 are spaced at a constant distance relative to the adjacent outer rings of the adjacent bearing (first or third bearing). In this way the preload of the second bearing 120 and of the fourth bearing 140 can also be changed by the preload device 150.

FIG. 1 shows an example of a preload device that is disposed outside the bearing of the bearing system. In other cases, for example in the case of a machine tool spindle, other arrangements of the preload device may be used in a manner analogous to one of the following examples and figures.

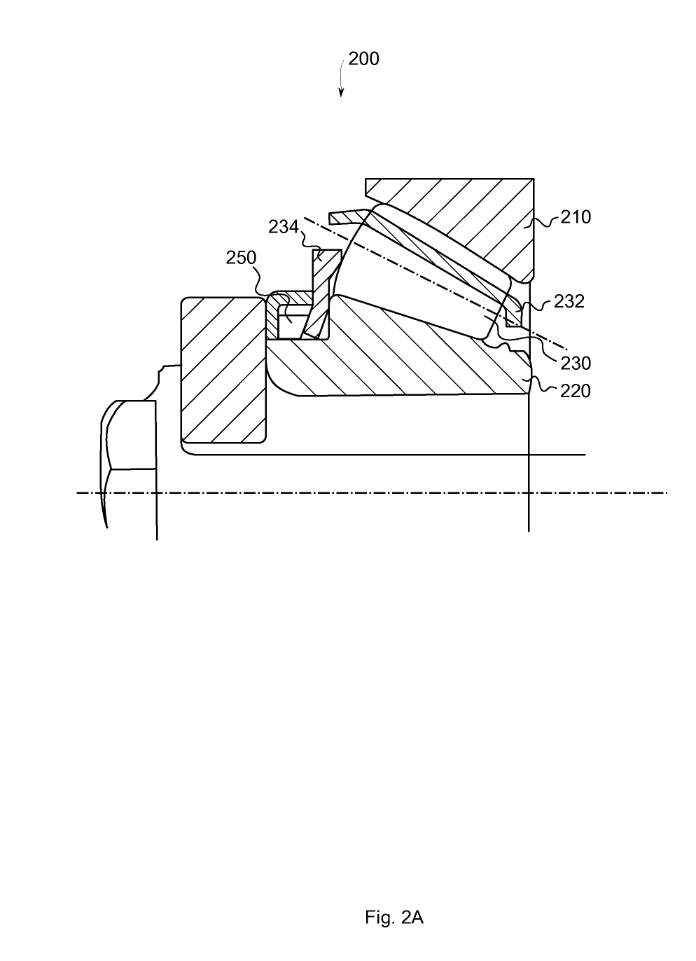

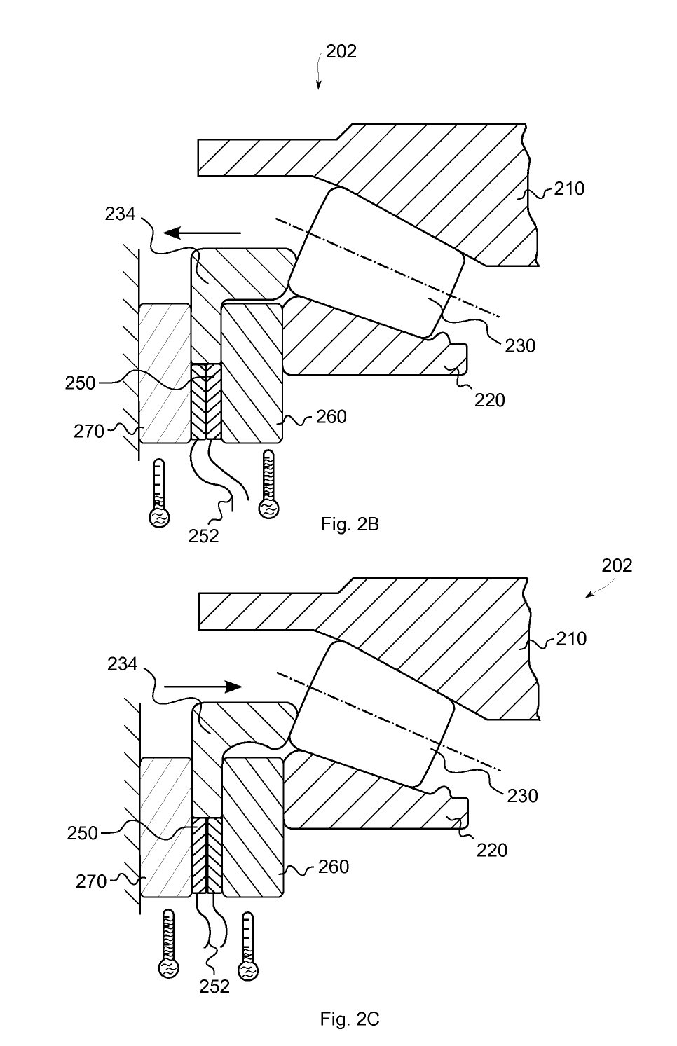

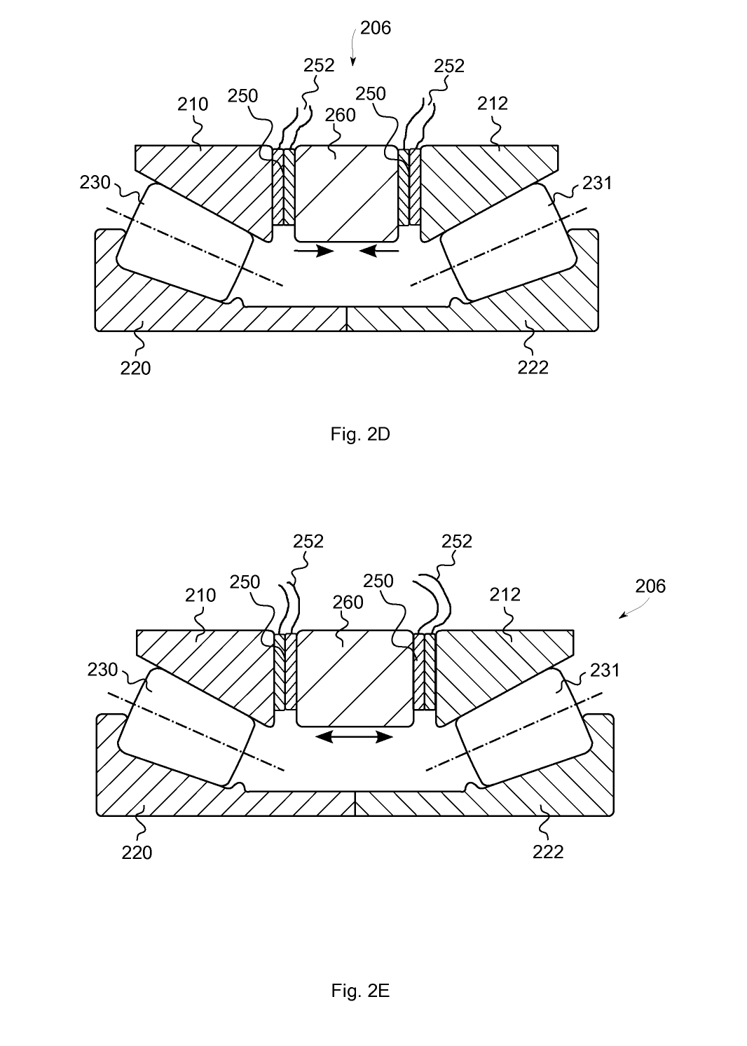

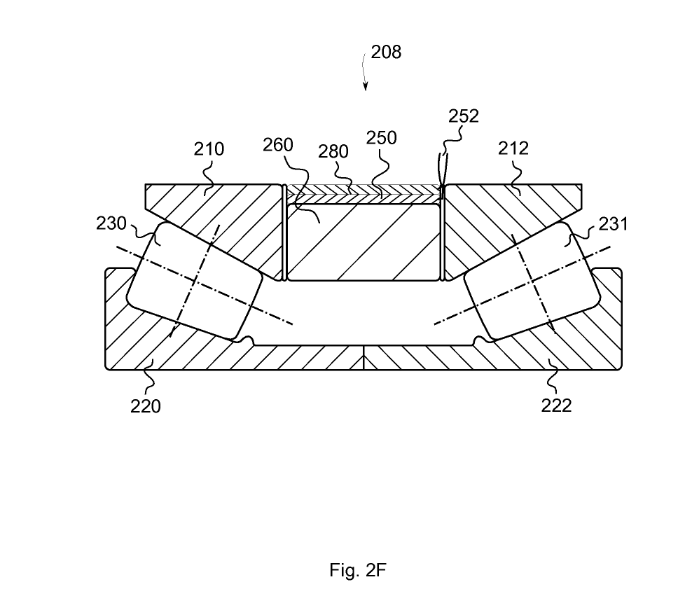

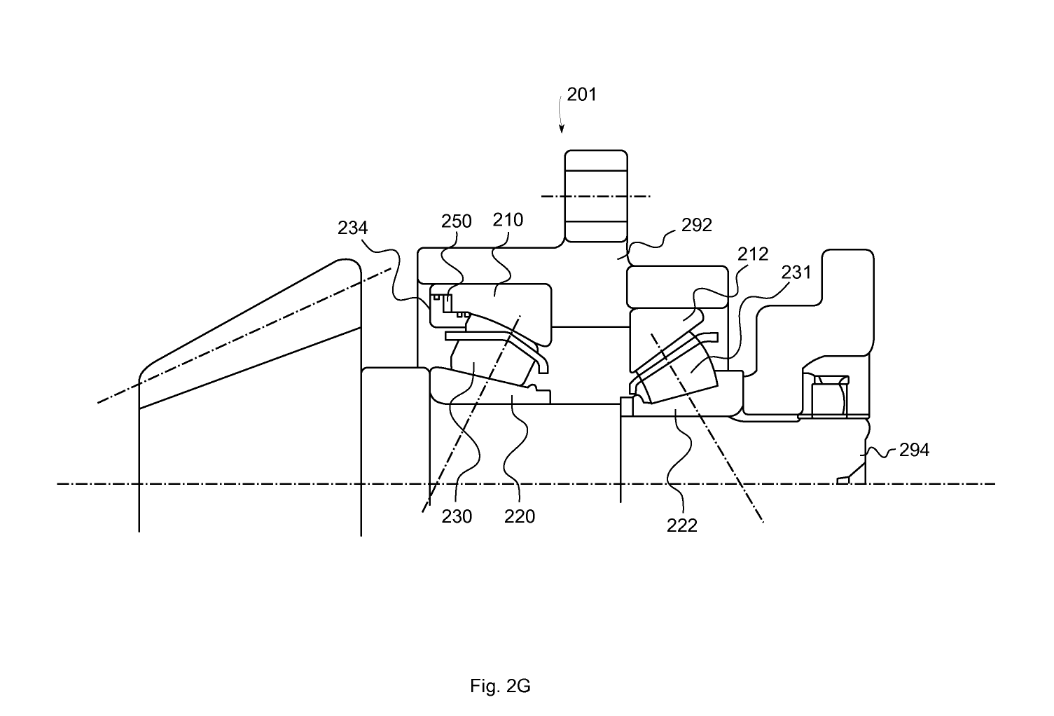

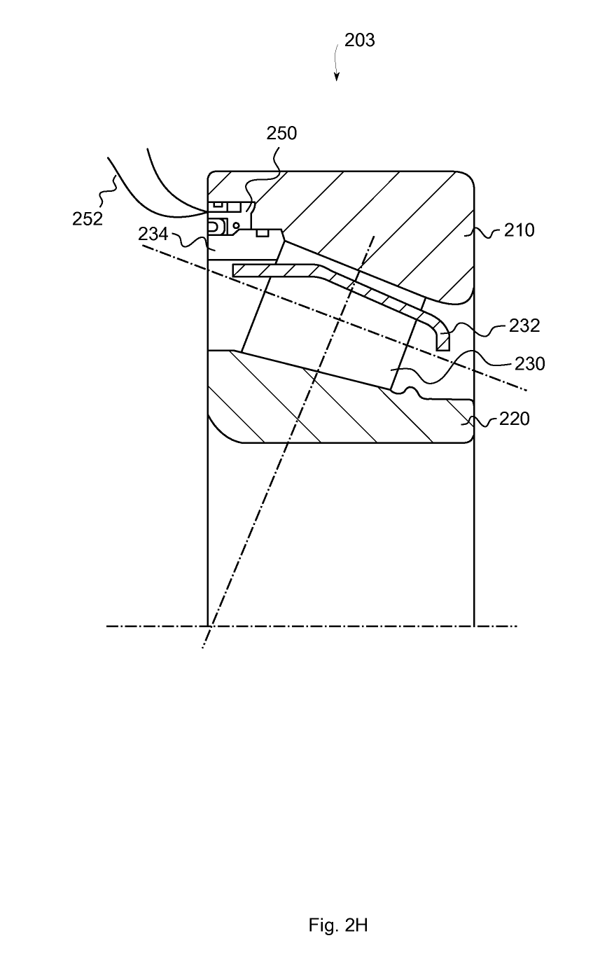

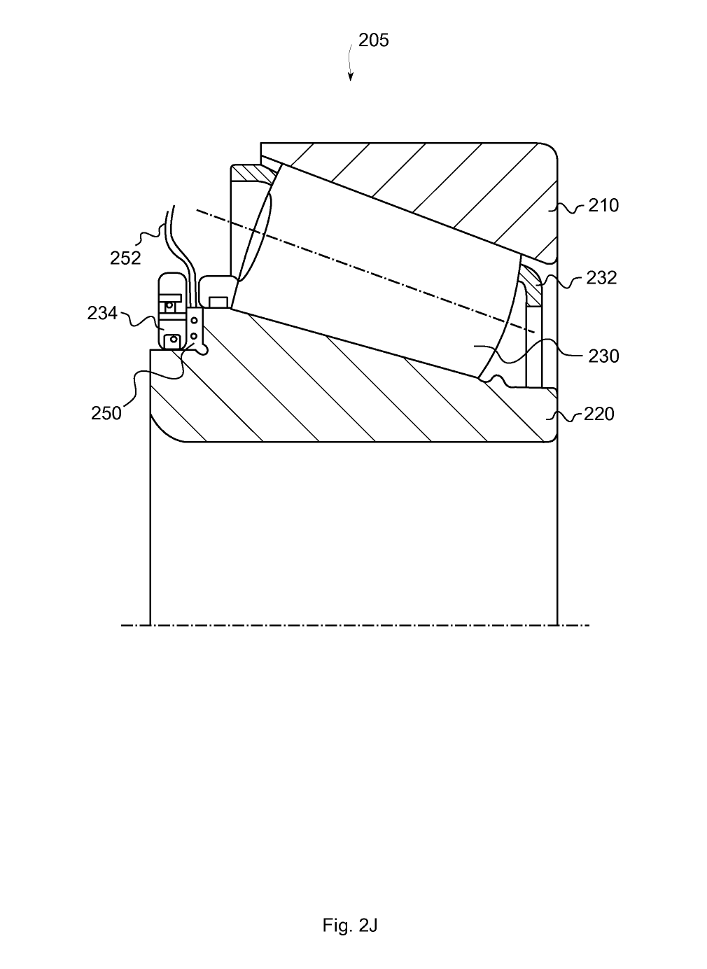

Alternatively or additionally, the preload device can be integrated into a bearing or part of a bearing. For example, FIG. 2a shows a partial cross-section of a tapered roller bearing in which the preload device 250 is integrated on the inner ring 220 so that it can set a contact pressure of the guide flange 234 on the rolling elements 230 of the tapered roller bearing 200. In this respect the tapered roller bearing 200 forms a complete bearing system. The preload device 250 may be formed as expansion material that expands when heated and a mechanism for heating and/or cooling the expansion material. While many materials expand when heated, as used herein, an expansion material is a material that, when heated, expands to a degree that is useful for changing a preload of a bearing in a desirable manner, and such an expansion material will generally have a coefficient of thermal expansion that is at least 10% greater than that of the material from which the bearings are formed. Alternatively, however, other above-mentioned preload devices 250 (e.g. a piezoelectric element) can be utilized in the recess on the inner ring 220. The outer ring 210 and the bearing cage 232 of the bearing are indicated in cross-section in FIG. 2a.

FIG. 2b shows a partial cross-section of a further tapered roller bearing 202 (bearing system). Similar to FIG. 2a, the preload device 250 of FIG. 2b is configured to vary the pressure that the guide flange 234 exerts on the rolling elements 230 of the tapered roller bearing 202. In this embodiment, the preload device 250 includes a Peltier element which can be attached via connecting wires or power supply wires 252, that maintains its opposing sides at different temperatures.

A first spacer ring 260 (lying axially closer to the rolling elements) and a second spacer ring 270 (lying axially further from the rolling elements) are located axially adjacent to the Peltier element. These spacer rings 260, 270 can include a material, or can be comprised of a material, which has a relatively high thermal expansion coefficient (e.g. relative to the material of the bearing rings or of the rolling elements of the bearing). In the example shown in FIG. 2b the side of the Peltier element which is adjacent to the axially-inner-lying spacer ring 260 has a higher temperature than the side of the Peltier element which is adjacent to the axially-outer-lying spacer ring 270. Thus, the relatively high temperature first spacer ring 260 expands and the relatively low temperature second spacer ring 270 contracts so that the guide flange 234 is axially displaced away from the rolling elements 230 of the tapered roller bearing 202, and this displacement decreases the preload. FIG. 2c correspondingly shows an inverse temperature distribution on the Peltier element, that is, shows the Peltier element controlled such that the first spacer ring 260 is cooler than the second spacer ring 270 so that the guide flange 234 is displaced axially toward the rolling elements 230 to increase the preload.

As a further exemplary embodiment, FIG. 2d schematically illustrates a partial cross-section of an O-arrangement, or back-to-back arrangement, of two tapered roller bearings of a bearing system 206. In this embodiment, the first tapered roller bearing includes, among other elements, an outer ring 210, an inner ring 220, and rolling elements 230, and the second tapered roller bearing includes, among other elements, an outer ring 212, an inner ring 222, and rolling elements 231. The preload device 250 and a spacer ring 260 are disposed axially between the outer ring 210 of the first tapered roller bearing and the outer ring 212 of the second tapered roller bearing. The preload device 250 includes a Peltier element between each of the outer rings 210, 212 of the two tapered roller bearings and the spacer ring 260. The Peltier elements can be electrically powered via connecting wires 252 to produce different temperatures on their opposing surfaces.

FIG. 2d illustrates an arrangement in which the sides of the Peltier elements facing the spacer ring 260 are cooler than the sides of the Peltier elements facing the outer rings 210, 212, so that the Peltier elements cool the spacer ring 260 and cause it to contract. The spacer ring 260 thus preferably includes or is comprised of a material that has a relatively high thermal expansion coefficient (e.g. more than 10%, 20%, 30%, or 50% higher than that of a material of an outer ring). A movement of the outer rings 210, 212 of the tapered roller bearing towards each other occurs when the spacer ring 260 is cooled which in turn reduces the preload of the tapered roller bearing.

FIG. 2e illustrates the device of FIG. 2d with the Peltier elements controlled to heat the spacer ring 260 and cause the spacer ring 260 to expand. This forces the outer rings 210, 212 apart from each other and increases the preload of the tapered roller bearing.

FIG. 2f illustrates a partial cross section of a bearing system 208 of a further exemplary embodiment. The configuration of the bearing system 208 substantially corresponds to that depicted in FIGS. 2d and 2e. However, in this embodiment, the spacer ring 260 is directly connected axially to the outer rings 210, 212 of the tapered roller bearing or is disposed axially between the outer rings. The Peltier element of the preload device 250 is disposed on a radially outer-lying surface of the spacer ring 260 (alternatively or additionally on a radially inner-lying surface) and can heat or cool the spacer ring 260 so that, due to its temperature-dependent length, the spacer ring 260 changes the distance between the outer rings of the tapered roller bearings. An insulator 280 (e.g. a body of thermal insulation) can be disposed on the radially-outer-lying surface of the Peltier element.

FIG. 2g shows a part of a cross-section of a further bearing system 201 including two tapered roller bearings in an O-arrangement similar to that shown in FIGS. 2d through 2f. In this embodiment, however, the preload device 250 is integrated into the first tapered roller bearing rather than being located externally between the two tapered roller bearings. A guide flange 234 of the tapered roller bearing can be axially shifted by the preload device 250 in a similar manner as that depicted in FIGS. 2a to 2c. In this example the preload device 250 is located in a recess of the outer ring 210 of the first tapered roller bearing. The preload device 250 may include a piezoelectric element or an expansion material which axially shifts the guide flange 234 of the first tapered roller bearing due to a change of the size of the piezoelectric element or the expansion material. This change in size thus changes the pressure on the rolling elements 230 of the tapered roller bearing and changes a preload of the tapered roller bearing. In the example shown in FIG. 2g, the second tapered roller bearing includes no additional preload device; however such an additional preload device can alternatively or additionally also be provided in the second tapered roller bearing. In the example shown the outer rings of the tapered roller bearing are connected via an external component 292 (e.g. housing part), and the two inner rings 220, 222 are attached to a shaft 294.

FIG. 2h schematically shows a partial cross-section of a tapered roller bearing 203 (bearing system) including an integrated preload device 250. The tapered roller bearing 203 has a similar design to that of the tapered roller bearing depicted in FIG. 2a; however the preload device 250 is located in a recess of the outer ring 210 instead of a recess of the inner ring. The preload device 250 includes an expansion material (e.g., wax) the size and/or length and/or volume of which can be changed by applying heat with an electric element (e.g., connected via connecting wires 252). This change in size of the expansion material displaces the guide flange 234 of the tapered roller bearing 203 toward or away from the rolling elements 230 in order to change the preload of the tapered roller bearing 203.

FIG. 2j shows a further example of a tapered roller bearing 205 (bearing system) including a preload device 250 located in a recess of the inner ring 220. Furthermore, the design is similar to the tapered roller bearings depicted in FIGS. 2a and 2h, and the corresponding descriptions of those embodiments apply.

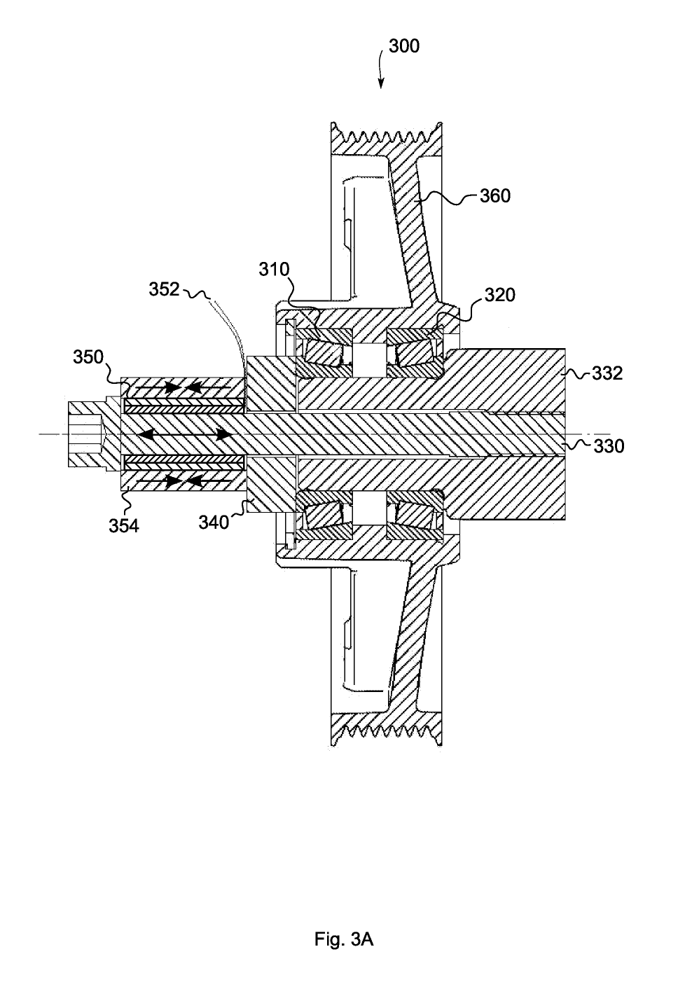

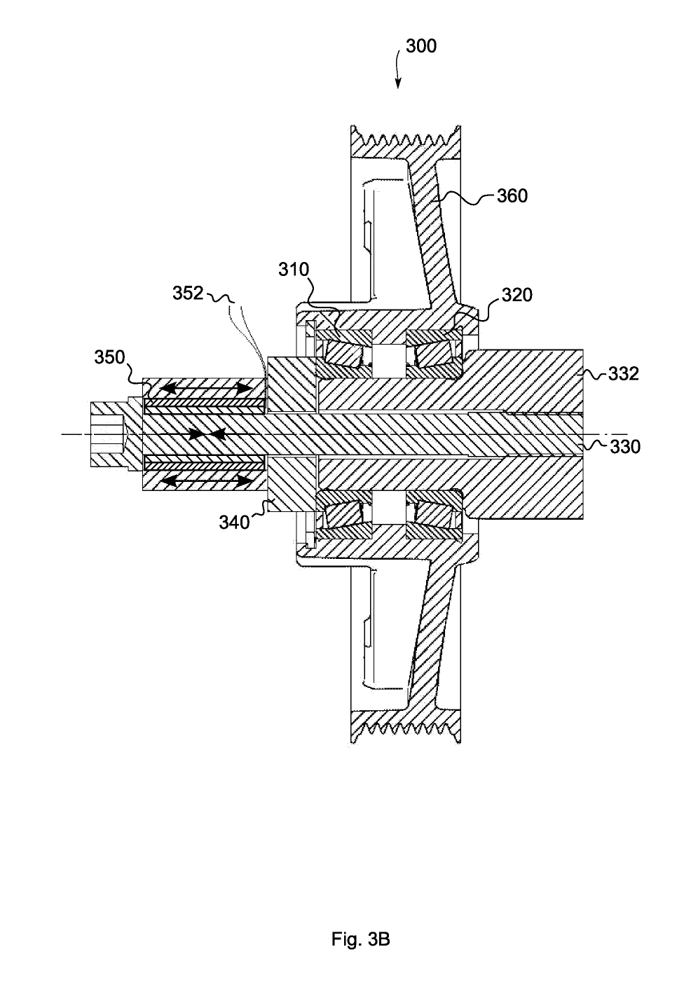

FIG. 3a shows a cross section of a bearing system 300 having two tapered roller bearings 310, 320 in an O-arrangement. Here the preload device 350 is disposed outside the bearing and is configured to change a spacing of the inner rings of the two tapered roller bearings from each other. The outer rings in both tapered roller bearings 310, 320 are connected to an external component 360 (e.g. a housing). The inner rings of the two tapered roller bearings 310, 320 are connected to a shaft 330 or to a component 332 which is connected to the shaft 330 for rotation therewith. Here the inner ring of the first tapered roller bearing 310 is at least somewhat axially displaceable along the shaft 330 or is disposed on the component 332 which itself is at least somewhat axially displaceable along the shaft 330.

The preload device 350 includes a Peltier element which surrounds the shaft 330 in an axial region. The Peltier element is surrounded by a preload ring 354. A spacer ring 340 is disposed axially between the preload ring 354 and the inner ring of the first tapered roller bearing 310. The Peltier element is electrically connected via connecting wires 352 and can thus bring the shaft 330 and the preload ring 354 to different temperatures. For example, the shaft 330 can be heated and the preload ring 354 can be cooled so that in this axial region of the shaft the shaft 330 expands and the preload ring 354 contracts, as indicated by the arrows in FIG. 3a. The spacing of the inner rings of the two tapered roller bearings thereby increases, which reduces the preload of the two tapered roller bearings. An opposite temperature distribution is indicated in FIG. 3b. In this embodiment, the shaft is cooled and the preload ring 352 is heated in order to reduce a distance between the inner rings of the two tapered roller bearings and increase the preload of the two tapered roller bearings.

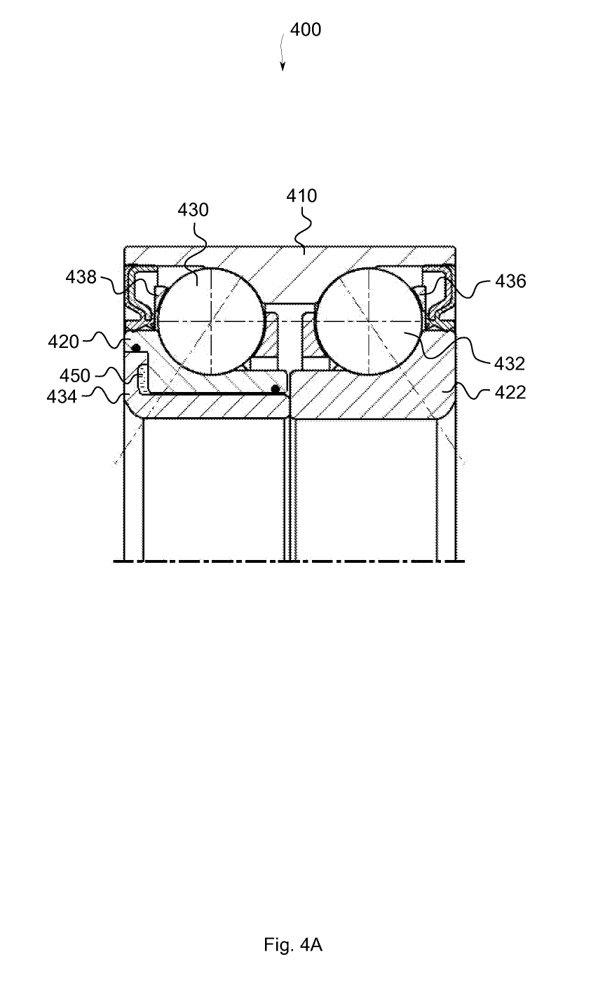

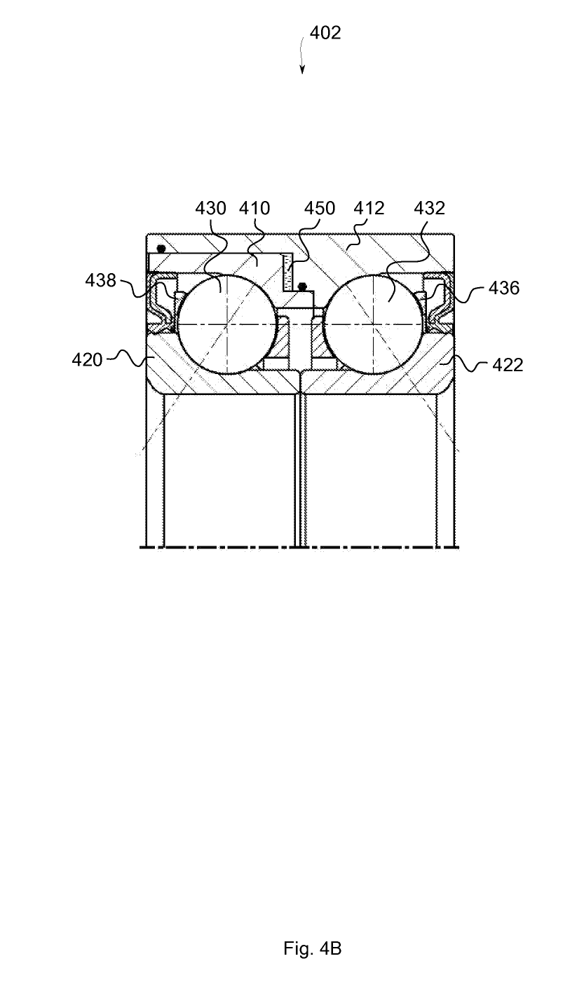

FIG. 4A is a partial schematic cross section of a bearing system 400 including angular contact ball bearings. The two angular contact ball bearings have a common outer ring 410, and each angular contact ball bearing has an inner ring 420, 422. Furthermore, rolling elements 430, 432, and bearing cages 438, 436 of both angular contact ball bearings are shown. The inner ring 420 of at least one of the two angular contact ball bearings additionally includes a spacer ring 434 which (within the scope of the adjustable preload) is axially movable with respect to the inner ring 420 of the at least one angular contact ball bearing and which axially abuts on the inner ring 422 of the other angular contact ball bearing. The preload device 450 comprises an expansion material disposed in a recess between the inner ring 420 of the first angular contact ball bearing and the spacer ring 434. By changing the volume of the expansion material (for example, by heating or cooling it), the spacer ring 434 can be moved in the axial direction with respect to the inner ring 420 of the first angular contact ball bearing. The spacer ring 434 can thereby push the inner ring 422 of the second angular contact ball bearing axially away from the first angular contact ball bearing, or allow it to be pulled in or approach the first angular contact ball bearing, so that the preload of the two angular contact ball bearings is changed.

FIG. 4b shows a partial schematic cross-section of a further bearing system 402 including two angular contact ball bearings. The design of the bearing system 402 is similar to that of the bearing system shown in FIG. 4a. However, each of the two angular contact ball bearings in this embodiment includes an outer ring 410, 412. The preload device 450 is an expansion material disposed in a cavity between the two outer rings 410, 412 of the two angular contact ball bearings. The outer rings of the two angular contact ball bearings can be axially displaced from each other or brought closer to each other by a change of the volume of the expansion material (e.g., by changing its temperature) so that the preload of the two angular contact ball bearings can be changed.

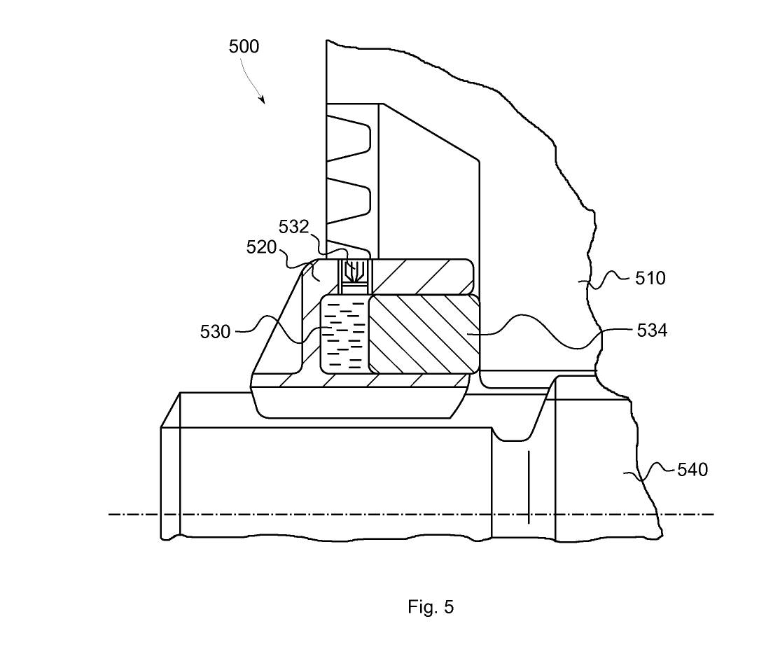

FIG. 5 shows a partial schematic cross-section of a bearing system 500 as a further embodiment. In this embodiment, the preload device is implemented as a clamping nut 520 having fine adjustment. The clamping nut 520 has a cavity 530 including an axially displaceable component 534 located therein. A hydraulic fluid (or, e.g., an expansion material) is located in the space between the axially displaceable component 534 and the clamping nut 520. The volume in which the hydraulic fluid (or the expansion material) is located can be changed by turning a set screw 532, and this change in volume pushes the axially movable component 534 axially out of the clamping nut 520 or allows it to axially recede into the clamping nut 520. The set screw 532 may be operated by an electric motor so that the axially movable component 534 can be moved axially during the operation of the bearing system 500. The axially movable component 534 is configured to exert or change a pressure on an inner ring or a guide flange of a bearing so that the preload of the bearing can be changed. In the example shown in FIG. 5, the axially displaceable component 534 presses on an inner ring 510 of a bearing, and the clamping nut 520 is disposed on a shaft 540.

The exemplary embodiments shown above provide, for example, active adjustable angular contact ball bearings, pinion units including a displaceable guide flange on the outer ring, clamping nuts having fine adjustment, tapered roller bearings including a displaceable guide flange on the inner ring, or tapered roller bearings having a displaceable guide flange on the outer ring.

Some exemplary embodiments related to a bearing system which is actively adjustable in terms of the preload. For example, a favorable preload can be chosen and set which is suitable for most load conditions. For example, in a spindle bearing the highest permitted rotational speed range can be used for the selection of a preload (for this operating state) in order to make the bearing friction controllable in the case of low preload. For example, at half rotational speed, which is usually encountered much more often, the bearing system can be set with a higher preload without overheating. Therefore a greater stiffness and thus a greater load capacity can be achieved in order to be able to select a more economical feed rate.

As another example, in wind turbines, low bearing preloads with low friction torque development are desirable in low wind conditions, while in a storm, a higher bearing preload can be set.

A bearing system whose preload can be adjusted based on its operating conditions provides for, in addition to increased efficiency, a lower bearing temperature and thus a higher lubricant service life.

The described concept can be both retrofitted into existing spindles and be provided in new constructions from the outset. In addition, it can be used in many other industrial applications where changing a bearing preload as described herein may be advantageous.

In a bearing system as described, the friction loss can be reduced to what is necessary and thus the temperature and the load capacity and bearing service life can be increased.

The bearing need no longer (permanently) be adjusted and set to the worst-case load because active adjustment of the bearing system to the requirements of an existing operating condition is possible.

In bearing systems the preload can be set by the position of a bearing or of a bearing group with respect to another bearing or another bearing group. For example, ground rings can be used to change the preload (e.g. for setting an initial preload) in a bearing. Various physical principles can be used for the further displacement of a bearing group. For example, Peltier elements, piezoelectric crystals, or expansion materials can be used.

Using the described concept, a reduced friction loss and thus a higher efficiency, a higher load capacity of the bearing in specific operating states, a reduced operating temperature in most load cases and/or an increased lubricant service life can be obtained.

As an example, a spindle bearing including a drawn piezoelectric element is represented in FIG. 1.

Some exemplary embodiments relate to a tapered roller bearing (TRB) the preload of which is actively adjustable. Currently, for example, in many applications the selection of the preload of a bearing system, which includes, for example, a TRB (tapered roller bearing) and an ACBB (angular contact ball bearing) or constructed from two TRBs, is a compromise which takes into account a borderline operating case. Thus a higher preload was often chosen than was needed for most other operating states. Using the described concept, the preload can be changed as required by existing operating conditions, and the bearing system no longer need be, for example, operated with constant higher frictional resistance. By reducing the friction loss, a higher efficiency and a lower thermal load on the bearing and its lubricant is made possible. In other words, a bearing that can actively set only the necessary (or an appropriate) preload according to the respective load state (or operating state) can also make possible, in addition to the increased efficiency, a lower bearing temperature and thus a higher lubricant service life.

In addition to, for example, an application in automotive bearings, the described concept can also be used in many other industrial applications.

Using a proposed bearing, the friction loss in a preloaded bearing can be reduced to a necessary amount, and thus the temperature and the bearing service life can be increased.

In tapered roller bearings the preload can be set by the position of a bearing guide flange. A displaceable or tiltable guide flange can be used to change the preload in a bearing. Various physical principles can be used for the necessary displacement. For example, a Peltier element, a piezoelectric crystal, or an expansion material can be used.

Using the described concept a bearing friction loss can be reduced and efficiency can thus be increased, the operating temperature can be reduced in most load cases, and/or the lubricant service life can be increased.

Some of the exemplary embodiments discussed above relate to a tapered roller bearing with a guide flange displaceably guiding the inner ring (IR) or the outer ring (OR) or to bearing systems including Peltier elements (which are simple to integrate, but due to the given heat conduction can potentially be more difficult to implement).

Some exemplary embodiments relate to a method for operating a bearing system for supporting components which are movable with respect to one another. The method comprises changing a preload of at least one bearing of a bearing system based on an operating state of the bearing system.

Optionally, the method can comprise further steps which correspond to one or more of the above-described aspects in connection with the general concept or one of the exemplary embodiments.

The features disclosed in the foregoing description, in the claims that follow, and in the drawings can be relevant individually, as well as in any combination, to the realization of the invention in its various embodiments.

Although some aspects of the present disclosure have been described in the context of a device, it is to be understood that these aspects also represent a description of a corresponding method, so that a block or a component of a device is also understood as a corresponding method step or as a characteristic of a method step. In an analogous manner, aspects which have been described in the context of or as a method step also represent a description of a corresponding block or detail or feature of a corresponding device.

The above-described exemplary embodiments represent only an illustration of the principles of the present disclose. It is understood that modifications and variations of the arrangements and details described herein will be clear to other persons of skill in the art. It is therefore intended that the invention be defined by the following patent claims, and not be limited by the specific details which have been presented with reference to the description and the explanation of the exemplary embodiments.

### REFERENCE NUMBER LIST

100 Spindle bearing
110 Bearing
120 Bearing
130 Bearing
140 Bearing
150 Preload device
160 Inner component
170 Outer component
200 Tapered roller bearing
201 Bearing system
202 Tapered roller bearing
203 Tapered roller bearing
205 Tapered roller bearing
206 Bearing system
208 Bearing system
210 Outer ring
212 Outer ring
220 Inner ring
222 Inner ring
230 Rolling element
231 Rolling element
232 Bearing cage
234 Guide flange
250 Preload device
252 Connecting wires
260 Spacer ring
270 Spacer ring
280 Insulation
292 Outer component
294 Shaft
300 Bearing system
310 Tapered roller bearing
320 Tapered roller bearing
330 Shaft
332 Component
340 Spacer ring
350 Preload device
352 Connecting wires
354 Preload ring
360 Outer component
400 Bearing system
402 Bearing system
410 Outer ring
412 Outer ring
420 Inner ring
422 Inner ring
430 Rolling element
432 Rolling element
434 Spacer ring
436 Bearing cage
468 Bearing cage
450 Preload device
500 Bearing system
510 Inner ring
520 Clamping nut
530 Cavity
532 Set screw
534 Axially displaceable component
540 Shaft

We claim:

1. A bearing system for supporting components which are movable relative to one another, the bearing system comprising:
at least one bearing; and
preload means for changing a preload of the at least one bearing based on an operating state of the bearing system.

2. The bearing system according to claim 1, wherein the preload means is configured to set a first preload of the at least one bearing when the at least one bearing is operating in a first operating state and to set a second preload, different from the first preload, of the at least one bearing when the at least one bearing is operating in a second operating state.

3. The bearing system according to claim 1, wherein the preload device is configured to change the preload of the at least one bearing during operation of the at least one bearing.

4. The bearing system according to claim 1, further including a control device configured to control a changing of the preload of the at least one bearing by the preload device based on a detected operating state of the bearing system.

5. The bearing system according to claim 4, further including an operating-state-detection device configured to detect an operating state of the bearing system and provide information about the detected operating state to the control device.

6. The bearing system according to claim 1, wherein the preload device includes a Peltier element, a piezoelectric element, an expansion material, or a micromechanical element for changing the preload of the at least one bearing.

7. The bearing system according to claim 1, wherein the at least one bearing comprises a first rolling-element bearing and a second rolling-element bearing, each of the first rolling element-bearing and the second rolling-element bearing including two bearing rings, wherein the preload device is disposed outside the first rolling-element bearing and outside the second rolling-element bearing and is configured to change a distance between a bearing ring of the first rolling-element bearing and a bearing ring of the second rolling-element bearing.

8. The bearing system according to claim 1, wherein the at least one bearing is a rolling-element bearing and wherein the preload device is integrated into the bearing.

9. The bearing system according to claim 1, wherein the at least one bearing is a rolling-element bearing including a guide flange for rolling elements of the rolling-element bearing, and wherein the preload device is configured to change a pressure of the guide flange on the rolling elements of the rolling-element bearing.

10. A method comprising:
providing a bearing system for supporting first and second components movable relative to one another, the bearing system including at least one bearing; and
changing a preload of the least one bearing based on an operating state of the bearing system.

11. A bearing system for supporting components which are movable relative to one another, the bearing system comprising:
at least one bearing; and
an expansion material mounted relative to the at least one bearing such that a change in size or a change in volume of the expansion material changes a preload of the at least one bearing.

12. The bearing system according to claim 11, wherein the expansion material is configured to expand when heated and further including a heat source for heating the expansion material.

13. The bearing system according to claim 12, wherein the heat source comprise a Peltier element.

12. The bearing system according to claim 11, wherein the expansion material comprises a piezoelectric element.

13. The bearing system according to claim 11, wherein the expansion material comprises a body of material having a greater coefficient of thermal expansion than a material of the at least one bearing.

14. A method comprising:
providing a bearing system according to claim 11;
detecting an operating state of the bearing system; and
changing the size or volume of the expansion material based on the detected operating state of the bearing system.

15. The method of claim 14, wherein changing the size or volume of the expansion material comprises changing the size or volume of the expansion material during operation of the bearing system.
